(19) United States
(12) Patent Application Publication
(10) Pub. No.: US 2010/0070550 A1
(43) Pub. Date: Mar. 18, 2010

(54) METHOD AND APPARATUS OF A SENSOR AMPLIFIER CONFIGURED FOR USE IN MEDICAL APPLICATIONS

(75) Inventor: James S. Hein, Madison, WI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Cardinal Health 209 Inc., Madison, WI (US)

(21) Appl. No.: 12/395,774

(22) Filed: Mar. 2, 2009

Related U.S. Application Data
(60) Provisional application No. 61/096,638, filed on Sep. 12, 2008.

(51) Int. Cl. G06F 17/10; G06F 17/17

(52) U.S. Cl. 708/311; 708/313

(57) ABSTRACT

A digital data bandpass filter process using digital signal processing processes raw digital data twice using distinct all-pass filters, wherein the two filters perform different frequency-dependent phase shifts of the digital content. The two filter output streams may be subtracted to remove out-of-band energy. The process produces lower levels of noise and conversion artifacts when used for filtering fixed-point data that may have low energy, and thus few non-zero bits, in the analog input signals, than conventional digital bandpass filters.

This application claims priority from U.S. Provisional Patent Application 61/096,638 filed Sep. 12, 2008, the entire contents of which are hereby incorporated herein by reference.

### FIELD OF THE INVENTION

The present invention relates generally to acquisition, storage, transfer, and display of medical data in electronic form. More particularly, the present invention relates to a method and apparatus for passing visual images and sensor data between stations, realizing a high rate of information transfer in a low system bandwidth environment, while ensuring confidentiality. Even more particularly, the present invention relates to a method and apparatus for synchronizing signals between a digitized and Ethernet-transmitted television signal stream (video and audio) and a digitized and Ethernet-transmitted medical measurement telemetry stream, and to a method and apparatus for reducing digitized signal noise within a medical measurement telemetry stream.

### BACKGROUND OF THE INVENTION

In certain medical and research environments, such as hospitals, clinics, laboratories, doctors' offices, and similar locations, significant numbers of patients (potentially termed clients or subjects in some environments, and potentially nonhuman or inorganic in other environments) may be monitored simultaneously by test apparatus. Where such monitoring is prolonged, such as in intensive care wards, sleep clinics, research laboratories, and other environments, high-performance, and thus costly and relatively scarce, apparatus may be in significant demand, while data furnished by such apparatus may require nurse, clinician, or other user attention with high update frequency, capability to access extended amounts of archival data, or other potentially high bandwidth needs. As automation has advanced, centralized locations, such as nurses' stations, have increased in technical complexity, with monitoring, display, and storage devices placed remotely from points of data acquisition, both to reduce staffing needs and to control the test environment, particularly during overnight monitoring periods.

Known technologies, specifically for applications requiring video image transfer and monitoring of vital signs, have migrated at least in part from all-analog functionality toward all-digital equivalence. While potentially offering data management advantages as digital information storage costs have declined, digitization neither intrinsically improves data throughput, nor assures technical integration of telemetry with imaging. Synchronization of video/audio signal streams and physiological and other measurement data streams is a shortcoming of present practice.

There exist numerous other technical limitations of current practice. Some of these are related to analog-to-digital conversion and related signal processing needs, specifically including filtering methods for low-amplitude, low-frequency signals. Others are related to communication handshaking for establishing and maintaining data flow between elements of a network-based multi-element monitoring system.

Accordingly, there is a need in the physiological sensor art for improved methods for establishing linkage between networked sensing, display, and recording elements, for digital data and streaming video/audio synchronization, and for signal processing techniques in advance of those in current use.

### SUMMARY OF THE INVENTION

Preferred embodiments of the invention provide a data acquisition and management system that combines multiple channels of sensor data acquisition, digitization, and resolution management with camera-based image and sound acquisition, digitization, selective frame rate control and pixel decimation, followed by message construction and transmission. A system may further include Ethernet interface, multi-subject and multi-viewer information flow control, and individualized display presentation and formatting. A system may further include digital filtering with reduced filter-generated noise artifacts. Embodiments of the invention provide sensor data stream synchronization time stamps embedded within digitized video/audio data streams, so that the two distinct streams of a patient monitor can be unambiguously resynchronized at any time.

In a first aspect, a filter for fixed-point digital data is presented. The filter includes a first all-pass digital filter, wherein the first filter performs relative phase shift between constituent signal frequencies within data output from the analog-to-digital converter with a first predetermined profile of frequency-dependent relative phase shift, and wherein the first filter outputs phase-shifted data characterized by the first relative phase shift profile, a second all-pass digital filter, wherein the second filter performs relative phase shift between constituent signal frequencies within data output from the analog-to-digital converter with a second predetermined profile of frequency-dependent relative phase shift, and wherein the second filter outputs phase-shifted data characterized by the second relative phase shift profile, and a summer, wherein the summer accepts as inputs the outputs of the two all-pass filters, wherein the summer provides as an output the algebraic sum of the signals provided from the filters, wherein amplitude of content within at least a first predetermined frequency range reinforces through summing, and wherein amplitude of content within at least a second predetermined frequency range is canceled at least in part through summing.

In another aspect, a filter for fixed-point digital data is presented. The filter includes a first digital signal processing embodiment (DSP) that accepts as input a digital data sequence that may include a plurality of frequency components, wherein the first DSP performs an all-pass filter function having a first spectral profile, and wherein the first DSP provides as output a first-DSP digital data sequence characterized by differential phase shift of the frequency components with reference to the input sequence. The filter further includes a second DSP that accepts as input the same digital data sequence, wherein the second DSP performs an all-pass filter function having a second spectral profile, and wherein the second DSP provides as output a second-DSP digital data sequence characterized by differential phase shift of the frequency components that differs from the differential phase shift characterizing the first DSP output. The filter further includes a third DSP that accepts as inputs the first and second DSP outputs, wherein the third DSP provides as output an algebraic sum of the first and second digital data sequences characterized by reinforcement of frequency components within at least a first frequency range and cancellation at least in part of frequency components within at least a second frequency range.

In yet another aspect, a method for filtering fixed-point digital data is presented. The filtering method includes applying a first all-pass filter function to an input having the form of a first succession of digital words comprising data signal samples, wherein the first filter provides an output having the form of a second succession of digital words, wherein the phase of frequency components of the data signal samples is shifted differentially in accordance with predetermined parameters of the first filter. The filtering method further includes applying a second all-pass filter function to an input having the form of a first succession of digital words comprising data signal samples, wherein the second filter provides an output having the form of a third succession of digital words, wherein the phase of frequency components of the data signal samples is shifted differentially in accordance with predetermined parameters of the second filter, and wherein the phase shift of the second filter differs from the phase shift of the first filter. The filtering method further includes applying a summing function to the outputs of the first and second all-pass filters, wherein the summing function provides an output having the form of a fourth succession of digital words, wherein the difference in phase shift between the respective filters differentially applies reinforcement to frequency components over at least a first frequency range and performs cancellation at least in part to frequency components over at least a second frequency range of the spectral content of the data signal samples.

There have thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. It is also to be understood that the phraseology and terminology employed herein, as well as the abstract, are for the purpose of description, and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a sensor amplifier configured for use in medical applications in accordance with the present invention.

FIG. 2 is a block diagram of a sensor amplifier in accordance with FIG. 1.

FIG. 3 is a block diagram of a filter in accordance with the invention.

FIG. 4 is a waveform diagram of an analog function corresponding to the function of the digital filter of the invention.

### DETAILED DESCRIPTION

The invention will now be described with reference to the drawing figures, in which like reference numerals refer to like parts throughout. An embodiment in accordance with the present invention provides self-contained multi-channel amplifiers and filters for medical applications, separate headboxes—that is, passive interface units having input ports mechanically and electrically compatible with medical sensor leads, and having output ports configured to connect directly or by signal cables to amplifier/filter units' input ports—one or more video input ports, signal processing facilities for formatting and/or structuring the data acquired by the amplifier/filter channels and the video channels, and bidirectional communication linkage to remote units via Ethernet communications protocols.

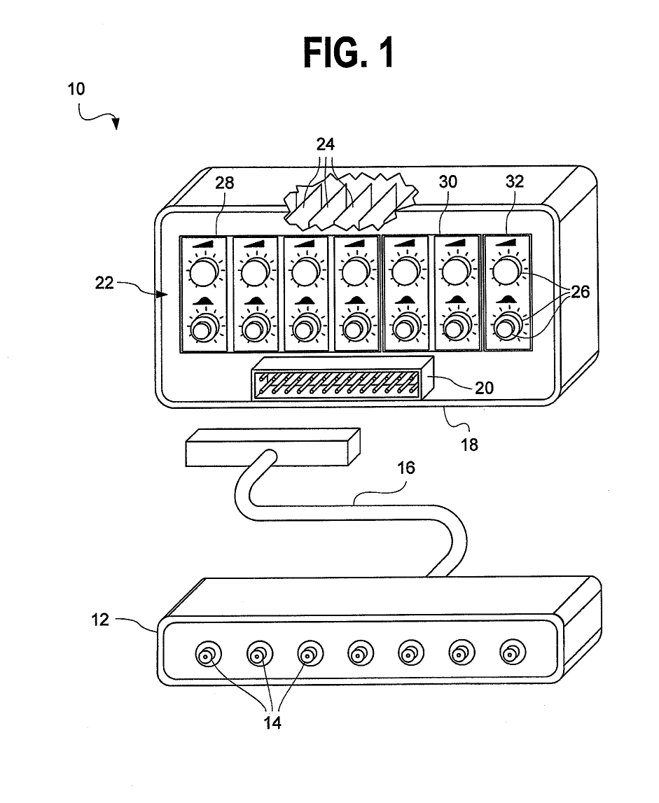

FIG. 1 shows an amplifier/filter 10 according to an embodiment of the invention. The amplifier/filter 10 includes a headbox 12, a term understood in the art to include a passive module having a plurality of input connectors 14 in a suitable configuration to support attachment of art-standard devices such as physiological sensor leads (not shown), and to provide a standard and/or consolidated output such as a connectorized cable 16. A representative headbox 12 is passive, that is, has connectors and wires but no active electronics, and exhibits little effect on signals detected by the sensor leads beyond minimal attenuation from distributed impedances.

The amplifier/filter 10 further includes an operational chassis enclosure 18 that includes a mating connector 20 for the cable 16 from the headbox 12. In the embodiment shown, the enclosure 18 includes a user interface 22 having a plurality of separate controllers 24 (located within the box) for the channels brought from the headbox 12 input connectors 14. It is to be understood that in other embodiments, the number of parameters per channel to be controlled may be so great—e.g., input impedance, DC coupling, filter low and high corners and/or rolloff, saturation recovery, analog and/or digital gain, converter sample rate, and the like—as to render infeasible the use of separate controls per parameter, as is represented by knobs 26 in FIG. 1. In such embodiments, physical presentation may include an on-amplifier keypad- or touchscreen-based user interface for parameter selection and modification, a port whereby the amplifier/filter 10 may be controlled from an external device such as a personal computer, access for configuration control via an Ethernet link to a remote location, another type of interface, or a combination of interfaces that may further be hierarchical, that is, one interface may be empowered to lock out or override another. Tradeoffs between direct visibility of configuration and enablement of highly flexible and remotely controllable configuration are known in the art, and are presented as novel herein only as noted.

Channels in a first group 28 in the embodiment shown may be dedicated to single-ended operation, that is, have a single input signal line referred to amplifier ground. Channels in a second group 30 may support both single-ended and differential operation—that is, include amplifiers that accept signal pairs isolated from signal ground within the amplifier/filter 10 (amplifier ground), and may selectively provide one or two ground-referred single-ended outputs or a single-ended output referred to the differential between the floating input lines. Channels in a third group 32—in the embodiment shown, there is one such channel—may likewise accept differential signals, but further enable direct current (DC) coupling in support of certain types of DC-referred signal transducers.

The channels 28, 30, and 32 may be configurable with high-pass and low-pass filters. Because the invention was developed with reference to medical measurements, with particular emphasis on electronic sensing of physiological phenomena related to electroencephalography (EEG), polysomnography (sleep studies), epilepsy, long-term maintenance (LTM), and other processes, many of which involve relatively low-frequency, low-amplitude sensor signals, low-pass filters for at least some embodiments can be configured to permit selection of rolloff at frequencies such as 250 Hz, as well as various lower frequencies, potentially down to a fraction of one hertz in some embodiments. The high-pass filters, switchable as noted on any DC-capable channels 32, and selectable in all channels in the embodiment shown, may block signals below 1 Hz, 0.053 Hz (roughly 20 seconds period) or other useful lower limits. Since such filters may saturate, and may recover slowly in human terms, the filters may be configurable to support accelerated recovery in response to a manual command to reset, such as from a maximum (instantaneous) output to zero output.

Individual channel and/or all-channel gain may be selectable in some embodiments. Control over gain and both corner frequencies, as well as rolloff rate where applicable, may be accessed through software in at least some embodiments, permitting setup and operation to be preprogrammed or actively controlled from a location remote from that of the amplifier. Autoranging for gain or filter parameters may be desirable in some embodiments, either autonomously within each amplifier channel or using feedback either within the amplifier or from the remote (host) device that uses the collected data.

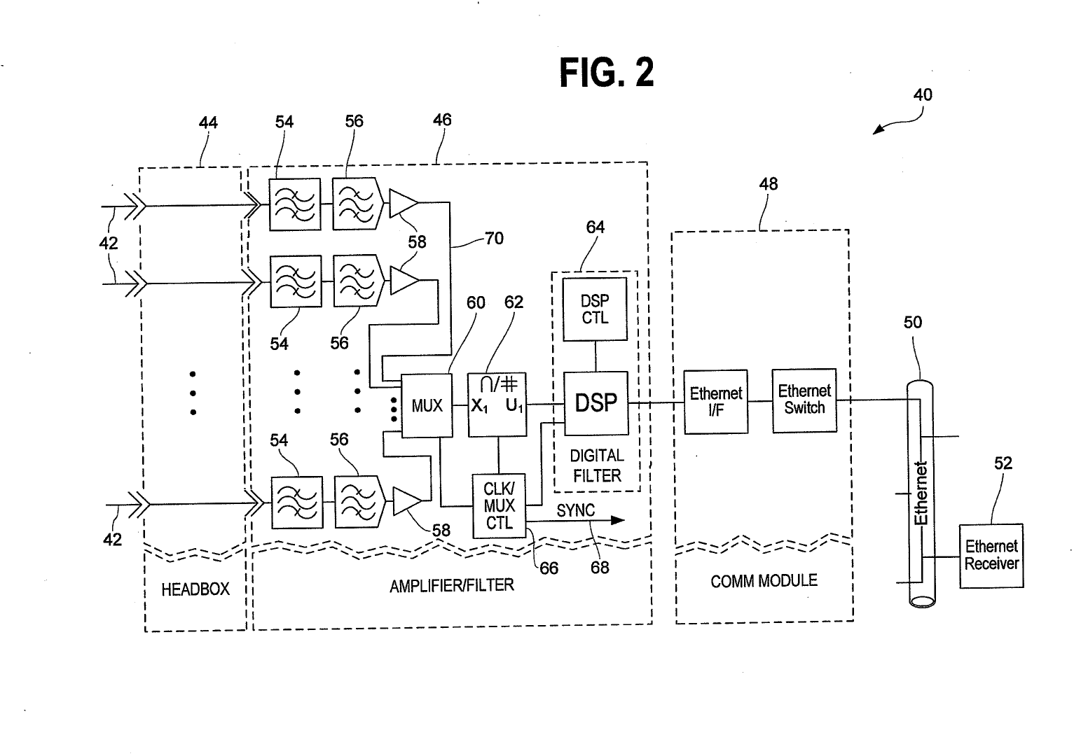

FIG. 2 is a functional block diagram 40 detailing aspects of the amplifier/filter of FIG. 1. The diagram 40 shows a plurality of input channels 42 and associated segments of a headbox 44, wherein the headbox 44 outputs are connected to an amplifier/filter 46 that supports the plurality of input channels 42, a communication module 48 configured for data flow through an Ethernet interconnection system 50, and a single receiver 52 to which data flows via the Ethernet connection 50.

The amplifier input channels 42 may include passive isolation networks (analog front ends) 54, incorporating switchable and/or nonswitchable filter elements (not shown) that may be insertable into the circuit manually or by software-based control signals in some embodiments. The passive analog front ends 54 may be followed by active analog front ends 56 having more switchable impedance units (not shown). Such arrangements can limit risk of saturation and aliasing by applying isolation and at least a portion of the filtering function before amplification (first gain section) 58, multiplexing 60, analog-to-digital (A/D) conversion 62 and digital filtering 64. The corollary to this is the necessity for the isolation networks 54 to have robust and low-noise components, while the signal applied to the first gain section 58 is quite low in maximum amplitude, requiring high gain and stability along with gain circuit 58 designs that realize low noise through component choice and circuit configuration.

Following the analog front end 54, 56, 58, a multiplexer (MUX) 60 sequentially applies the channels 42 to an A/D converter 62. A clock 66-driven synchronization signal 68 allows the channels 42 to be converted from analog 70, with all channels 42 synchronous within a time skew established by the clock 66. In some embodiments, all channels 42 may be captured virtually exactly synchronously using sample-and-hold circuitry per channel (not shown) ahead of the MUX 60, while in other embodiments, the successive samples may be skewed relative to one another according to the MUX 60 transfer rate, which corresponds generally to the arrangement shown in the block diagram 40. Yet another arrangement may be preferred in other embodiments, provided the arrangement selected realizes a raw digital signal 72 wherein each channel 42 is digitized with a selected sample rate and precision, and the sample times for all channels 42 are known relative to an initialization event.

Digitization and data capture may use any of a variety of methods, including but not limited to sample-and-hold followed by ramp or successive approximation, delta-sigma conversion with or without sample-and-hold, and other methods known or to be developed. Similarly, hardware complexity may be controlled by methods such as multiplexing 60 all channels 42 into a single, relatively high-performance A/D converter 62, as shown, multiplexing 60 each few channels 42 into one of several slower A/D converters 62, then consolidating the multiple channels of digital data using digital data management techniques (not shown), or assigning a dedicated A/D converter 62 for each channel 42, with no analog MUXs 60, and with all data consolidation managed in the digital domain (not shown).

In each of these and other arrangements, sample skew may be managed separately from conversion strategy, in view of considerations such as power draw-induced noise. For example, use of a large number of slow, low-power A/D converters 62, all clocked to convert simultaneously, may cause power distribution transients that can introduce appreciable voltage errors in exchange for minimizing synchronization errors. The same A/D converters 62, clocked in sequence, may produce significantly less voltage error but have a pronounced skew across channels. Similar tradeoffs may be understood to apply for substantially all techniques and configurations. For applications such as physiological measurements, it may be noted that errors associated with channel-to-channel skew may be small enough to be unimportant provided the sample rate is, for example, well in excess of the Nyquist rate. It may be further noted that the extent of correlation from channel to channel may itself be low for at least some applications, and thus a minor consideration. It is further to be understood that skew errors may be substantially correctable by computational methods where the channel-to-channel delay is well defined.

In all such embodiments, the converted data may be stored at least once as an intermediate process. Where multiplexing is employed, the converted data may be managed in multiplexed form, such as by rendering the overall processing substantially synchronous, so that each datum is used or reused at predetermined intervals, or by associating an identifier with each datum, so that each process is performed in accordance with instructions attached to the data. In other embodiments, data may be distributed to storage locations associated with the input channels, such as by using the addressing that controls the multiplexer, with processing performed on discrete address blocks. Tradeoffs between intermediate data management strategies affect at least physical size, interconnection complexity, programming complexity, and end-to-end processing speed of data manipulating devices. Such tradeoffs are well known in the art, and are not addressed herein further than to identify a general strategy and to observe that a range of solutions can provide similar, albeit unequal, outcomes.

A digital filter 64 is applied to the A/D converted signal 72 in the embodiment shown in FIG. 2. The filtered signal 74 is then combined 76 with other data 78 and formatted 80 for local storage 82 or transmission 84.

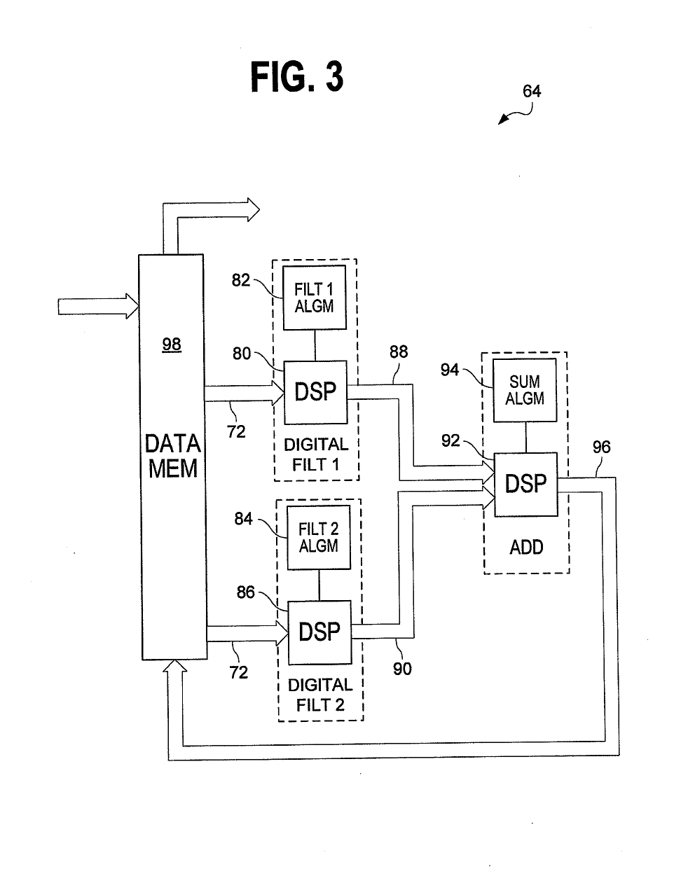

FIG. 3 shows the core filter function 64 of FIG. 2 in greater detail. A first digital signal processing (DSP) device 80 employed in the embodiment shown filters the raw digitized analog sensor data 72.

Known methods of DSP 80 coding—that is, software-based algorithms executed in computation-oriented digital electronic devices, along with related data management procedures—for filtering of low-amplitude, low-frequency sensor signals use Chebychev, Butterworth, Sallen-Key, Bessel, Cauer, state-variable, or like algorithms to provide filtering in a single function, with a knee location and an extent of rolloff (i.e., number and placement of poles) selected according to established methods. Such processes apply particular algorithms to sequences of data values, using data management methods such as rolling averages, sliding windows, and the like to process physiological measurements or other data captured and digitized at successive points in time.

In some filter embodiments, A/D converter 62 output 72 word length is finite and comparatively short, and fixed-point numbers rather than floating point are produced. Data processing speed in such embodiments may be rapid, permitting, for example, a single DSP 80 to perform all processing for a multichannel filter/amplifier. However, processing accuracy—and thus introduction of noise through processing—can be highly dependent on algorithm selection.

In some digital filters for fixed-point numbers, a given time sample may recur in a finite number of processing steps, and may be scaled to a different amplitude in each, for example. In other such filters, a calculation residue may be added back indefinitely, further attenuated each time, so that a sample that contributes to that residue gradually loses its importance compared to newer data elements. Effects of these and other filtering processes are well understood in the digital filtering art; error artifacts can include degradation of signal quality as a function of quantization noise—roundoff, finite word length, and the like—through multiple mathematical processes.

It has been demonstrated that the summation (with inversion and scaling as required) of at least two digital all-pass filter functions, each of which may be distinct in filter parameters, can realize a desired extent of band filtering—that is, high-pass, low-pass, or band-pass—while decreasing introduction of quantization noise into the signal so processed when compared to known methods of digital band filtering.

In the present invention, digitized, fixed-point data 72 is applied as digital filter 64 input, where a first DSP 80 executes a first digital all-pass filter algorithm. The first DSP 80 introduces a first spectrally profiled phase shift to the signal. The first digital all-pass filter algorithm is stored in a first filter-control element 82 and executed by the first DSP 80. This first all-pass filter algorithm applies phase shift to some spectral components of the digitized input signal 72 to the first DSP 80 that differs from phase shift applied to other spectral components of the same digitized input signal 72, while the relative magnitude of the spectral components may be substantially unaffected.

A second digital all-pass filter algorithm is similarly stored in a second filter-control element 84 and executed by the second DSP 86. Similarly to the first algorithm and DSP 80, the second DSP 86 introduces a second spectrally profiled phase shift to the input signal 72. Once again, the relative magnitude of the spectral components may be substantially unaffected.

A first digitized, all-pass-filtered intermediate signal 88 output from the first DSP 80 and a second digitized, all-pass-filtered intermediate signal 90 output from the second DSP 86 are then applied as inputs to a third DSP 92 that executes a summing algorithm 94 to yield an output signal 96. The digital signal stream 96, effectively bandpass-filtered, can then be passed through the system, such as by formatting the signal 96 as telemetry, by transmitting, storing, and recovering the signal 96 from a telemetry stream, by converting the signal 96 back to analog, by displaying the signal 96 as a voltage waveform, and the like.

Note that, as in band filters, all-pass digital filters may process successive data samples repeatedly in order to realize particular filter characteristics, storing intermediate values between processing steps, scaling and combining samples such as by shifting and adding, and the like. Because a plurality of all-pass filter algorithms exists, it is to be understood that selection of a digital all-pass algorithm may bear on several criteria, such as processor bandwidth, intermediate element storage resources, availability and cost of licenses for particular hardware or software, and the like.

It is to be understood that the DSP functions represented in FIG. 3 as functional blocks in a diagram are subject to realization in a plurality of embodiments. Such embodiments include at least software sequences stored in and executed from processor-readable memory, dedicated hardware in the form of specialized data handling circuitry, and logic processes loaded into gate array circuits preparatory to execution, as well as other known and future realizations.

The term digital signal processor is applied herein with reference to any of the above as well as to other technological realizations that permit rapid and repeated processing of digital data constructs, without preference for the approach selected for an embodiment. Similarly, references to algorithms that control the DSP are intended herein to refer at least to any control sequence for a general-purpose processor, dedicated DSP microcircuit, or like embodiment, or for a logic-based functional arrangement programmed into a programmable gate array microcircuit or like embodiment, wherein the control sequence or functional arrangement realizes at least a portion of a filter of the type described.

It is to be understood that a DSP may be realized as a processor that reads and executes software sequences stored in a machine-readable storage device. Such a device may be a self-contained general purpose computer that includes one or more microprocessors, memory devices, input-output features such as user interfaces and communication elements, power converters, and the like. Such a processor may instead be a general-purpose computing module such as a microprocessor-based circuit board enclosed within and interfacing to a specialized apparatus such as a multichannel amplifier. Such a processor may also be a general-purpose computing device embedded within a specialized apparatus such as a multichannel amplifier, supported by memory and interface components likewise embedded within the specialized apparatus.

The specific type of processor known in the art as a digital signal processor (DSP) may be an integrated circuit component with register architecture, instruction set, data handling capability, and other attributes more nearly optimized for repetitive data element manipulation than is a processor known in the art as a general-purpose computer. While a DSP is commonly configured as a component embedded within a specialized circuit board, and supported by co-located control, memory, interface, and other functional devices, other embodiments are realizable.

Equivalent functionality may be realized in still other embodiments, such as devices known in the art as field-programmable gate arrays (FPGAs), mask-programmable gate arrays, and custom and semi-custom integrated circuit components. FPGAs (the related types indicated herein are included within this acronym for brevity) may include so-called intellectual property (IP) embedded within the programmed device. Such IP, which term implies development by an entity that may be other than an end-product developer, may include the realization of a known microprocessor or DSP type, for example, in the form of a set of instructions to configure the interconnection of the gates within the FPGA to emulate the throughput and timing of that microprocessor or DSP when programmed with instructions compatible therewith. Memory, data handling, and other custom or IP functions may be embedded within one or more FPGA devices along with one or more microprocessors or DSPs, for example. Thus, the operations described herein may be performed in a variety of physical realizations.

It is further to be understood that the IP and associated functionality within an FPGA has physical realization at least during operation. That is, programming a group of gates within the FPGA causes the gates to be interconnected to perform a specific function, in a fashion electrically equivalent to the interconnection performed during fabrication of a non-programmable integrated circuit (IC), for example, so that the electrical properties of the FPGA during use may be indistinguishable from those of the IC. While some FPGA-class devices may support being configured only once, and must be deinstalled and replaced by other physical devices in order to modify operation of a product wherein the FPGAs are installed, other FPGAs are reprogrammable, so that product functionality may be revised, including dynamically in response to data flow or user input, for example.

The number of physical DSP devices 80, 86, 92 used may be selected according to such considerations as throughput requirements. In the embodiment shown, for clarity, three individual DSP devices are presented, each executing either a single all-pass filter algorithm function or an add function. In other embodiments, one DSP may be used, with the intermediate data stored in memory 98 as needed between successive operations that use different processes or filter parameters. In still other embodiments, multiple data channels may be processed by a single DSP or a triple-DSP data path similar to that shown. In yet other embodiments, three or more DSP devices may each perform all-pass filtering on a single data stream, followed by a summation process, or the same data may be processed four or more times by a single DSP with intermediate storage, or the like, in embodiments wherein a process using three or more digital all-pass filter steps is defined and is preferred. In each such embodiment, the inventive core function includes processing a digitized signal by a plurality of digital all-pass filters, followed by combining the results, with the digital output signal characterized by a preferred extent of filtering and a reduced extent of degradation of fixed-point content by quantization than in known high-, low-, or band-pass digital filters.

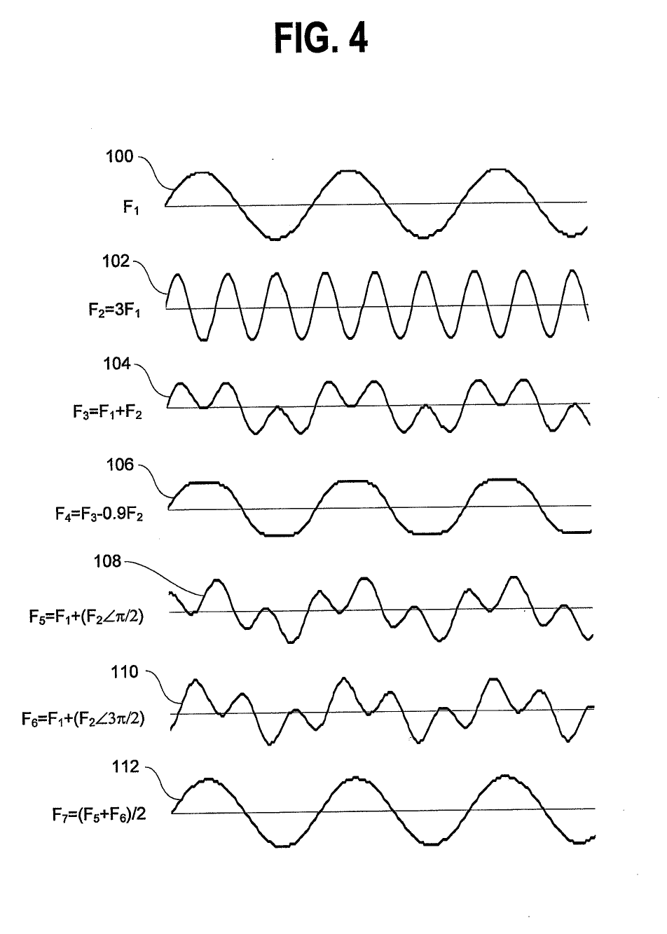

FIG. 4 presents a basic analogy to the inventive process, in the analog time domain, using a desired sine wave 100 upon which an undesired third harmonic 102 is superimposed (in phase, and at equal magnitude, in this example) to form a composite signal 104. A conventional analog low-pass filter may remove a substantial portion of the unwanted third harmonic 102, at significant cost in material complexity due to the proximity of wanted and unwanted components, while providing an imperfect realization 106. In contrast, the original composite signal can be passed through two all-pass filters, changing the relative phase of the components of the composite signal 104, providing a first all-pass output 108 and a second all-pass output 110. If these signals are then summed (assuming no clipping or degradation due to component noise), the shifted second harmonic signals may be canceled 112, arguably with a higher degree of accuracy in proportion to equipment cost than if a single low-pass filter is used. Analog-domain apparatus for realizing the waveforms shown in FIG. 4 may have a block diagram representation that somewhat resembles the digital-domain apparatus of FIG. 3, with operational amplifier-based filters and summers implementing the processing in lieu of data storage elements, DSP elements, software storage elements, and the like.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A digital filter for fixed-point digital data, comprising:
a first all-pass digital filter, wherein the first filter performs relative phase shift between constituent signal frequencies within data output from the analog-to-digital converter with a first predetermined profile of frequency-dependent relative phase shift, and wherein the first filter outputs phase-shifted data characterized by the first relative phase shift profile;
a second all-pass digital filter, wherein the second filter performs relative phase shift between constituent signal frequencies within data output from the analog-to-digital converter with a second predetermined profile of frequency-dependent relative phase shift, and wherein the second filter outputs phase-shifted data characterized by the second relative phase shift profile; and
a summer, wherein the summer accepts as inputs the outputs of the two all-pass filters, wherein the summer provides as an output the algebraic sum of the signals provided from the filters, wherein amplitude of content within at least a first predetermined frequency range reinforces through summing, and wherein amplitude of content within at least a second predetermined frequency range is canceled at least in part through summing.

2. The filter of claim 1, wherein the summer output data is characterized by attenuation of at least one of relatively low-frequency signal content, relatively high-frequency signal content, and both relatively low and relatively high frequency signal content.

3. The filter of claim 1, further comprising an analog-to-digital converter (ADC) interposed between analog electrical signal input circuitry and the digital filter.

4. The filter of claim 1, further comprising:
a first storage resource for digital data, wherein the first digital data storage resource is configured to accept ADC output data;
a second storage resource for digital data, wherein the second digital data storage resource is configured to accept data processed by the first all-pass digital filter; and
a third storage resource for digital data, wherein the third digital data storage resource is configured to accept data processed by the second all-pass digital filter.

5. The filter of claim 1, further comprising:
a digital signal processor (DSP), wherein the DSP is configurable to accept a sequence of digital data values as input, to implement at least one all-pass digital filter function, and to output a sequence of digital data values, wherein the output values are modified from the input digital data values by relative phase shift of signal component frequencies therewithin.

6. The filter of claim 3, further comprising:
a digital storage medium for a first set of instructions, wherein the first set of instructions includes at least data processing steps configured to apply a first relative phase shift to a plurality of signal component frequencies in a sequence of data elements;
a digital storage medium for a second set of instructions, wherein the second set of instructions includes at least data processing steps configured to apply a second relative phase shift to a plurality of signal component frequencies in a sequence of data elements; and
a digital storage medium for a third set of instructions, wherein the third set of instructions includes at least data processing steps configured to sum two digital data sequences and to scale the resultant.

7. The filter of claim 3, further comprising:
a passive analog front end, configured to accept as input a first plurality of distinct analog signals from a plurality of signal sources, and further configured to provide as output a second plurality of analog signals differing from the input signals principally in at least one of isolation, protection, and limiting;
an analog multiplexer (MUX), configured to accept from the passive analog front end the second plurality of analog signals, and further configured to accept a pattern of timing control signals, wherein the MUX further comprises a single analog signal output, wherein the single analog signal comprises successive samples of individual analog signals from the second plurality of analog signals, and wherein the successive samples are output in accordance with the pattern of timing control signals; and
a timing generator, configured to provide the pattern of timing control signals, wherein the pattern comprises a provision for selection between MUX input channels and a provision for initialization of ADC conversion actions.

8. The timing generator of claim 7, further comprising:
a set of control signals for the ADC, wherein the control signals for the ADC establish synchronization between the MUX and the ADC, wherein successive MUX output samples to the ADC are coupled thereto for a hold time compatible with ADC requirements, wherein the ADC control signals further trigger digitization of the successive MUX output samples, and wherein the ADC control signals further direct management of resulting digitized data at least in part.

9. The filter of claim 1, further comprising an active analog front end configured to accept as input a first plurality of discrete analog signals, and further configured to provide as output a second plurality of discrete analog signals differing from the input analog signals principally in at least one of impedance, gain, isolation, and offset.

10. The filter of claim 1, further comprising an Ethernet-compatible digital data transmitter, configured to transmit an indefinite stream of digital data elements derived from analog telemetry input signals.

11. A filter for fixed-point digital data, comprising:
first means for all-pass filtering an input having the form of a first succession of digital words comprising data signal samples, wherein the first means for all-pass filtering provides an output having the form of a second succession of digital words, wherein the phase of frequency components of the data signal samples is shifted differentially in accordance with predetermined parameters of the first means for all-pass filtering;
second means for all-pass filtering an input having the form of a first succession of digital words comprising data signal samples, wherein the second means for all-pass filtering provides an output having the form of a third succession of digital words, wherein the phase of frequency components of the data signal samples is shifted differentially in accordance with predetermined parameters of the second means for all-pass filtering, and wherein the phase shift of the second means for all-pass filtering differs from the phase shift of the first means for all-pass filtering;
means for summing the outputs of the first and second means for all-pass filtering, wherein the means for summing provides an output having the form of a fourth succession of digital words, wherein the difference in phase shift between the respective means for all-pass filtering differentially reinforces and cancels frequency components of the data signal samples.

12. The filter of claim 11, further comprising means for scaling at least one of the input and the output of the means for summing.

13. The filter of claim 11, further comprising means for converting analog signals to fixed-point digital form.

14. The filter of claim 13, further comprising:
means for accepting as analog front-end input a first plurality of discrete analog signals from a plurality of signal sources;
means for providing as analog front-end output a second plurality of discrete analog signals differing from the input signals principally in at least one of isolation, protection, and limiting;
means for accepting from the front end the second plurality of analog signals;
means for accepting a pattern of timing control signals;
means for providing as output a single multiplexed analog signal, wherein the multiplexed signal comprises successive samples of individual analog signals from the second plurality of analog signals, and wherein the samples are output in accordance with the pattern of timing control signals; and;
means for generating the pattern of timing control signals, wherein the pattern comprises a provision for selection between multiplexed input channels and a provision for initialization of conversion of a selected analog signal to digital form.

15. The filter of claim 11, further comprising:
means for storing a first digital data sequence comprising digitized and unfiltered analog data;
means for storing a second digital data sequence comprising data processed by the first all-pass digital filter; and
means for storing a third digital data sequence comprising data processed by the second all-pass digital filter.

16. A method for filtering fixed-point digital data, comprising:
applying a first all-pass filter function to an input having the form of a first succession of digital words comprising data signal samples, wherein the first filter provides an output having the form of a second succession of digital words, wherein the phase of frequency components of the data signal samples is shifted differentially in accordance with predetermined parameters of the first filter;
applying a second all-pass filter function to an input having the form of a first succession of digital words comprising data signal samples, wherein the second filter provides an output having the form of a third succession of digital words, wherein the phase of frequency components of the data signal samples is shifted differentially in accordance with predetermined parameters of the second filter, and wherein the phase shift of the second filter differs from the phase shift of the first filter;
applying a summing function to the outputs of the first and second all-pass filters, wherein the summing function provides an output having the form of a fourth succession of digital words, wherein the difference in phase shift between the respective filters differentially applies reinforcement to frequency components over at least a first frequency range and performs cancellation at least in part to frequency components over at least a second frequency range of the spectral content of the data signal samples.

17. The method of claim 16, further comprising scaling at least one of the input and the output of the summing function.

18. The method of claim 16, further comprising converting analog signals to fixed-point digital form.

19. The method of claim 18, further comprising:
accepting as analog front-end input a first plurality of distinct analog signals from a plurality of signal sources;
providing as analog front-end output a second plurality of analog signals differing from the input signals principally in at least one of isolation, protection, and limiting;
accepting from the front end the second plurality of analog signals;
accepting a pattern of timing control signals;
providing as output a single multiplexed analog signal, wherein the multiplexed signal comprises successive samples of individual analog signals from the second plurality of analog signals, and wherein the samples are output in accordance with the pattern of timing control signals; and
generating the pattern of timing control signals, wherein the pattern comprises a provision for selection between multiplexed input channels and a provision for initialization of conversion of a selected analog signal to digital form.

20. The method of claim 16, further comprising:
storing a first digital data sequence comprising digitized and unfiltered analog data;
storing a second digital data sequence comprising data processed by the first all-pass digital filter; and
storing a third digital data sequence comprising data processed by the second all-pass digital filter.
